(19) United States
(12) Patent Application Publication
(10) Pub. No.: US 2004/0131045 A1
(43) Pub. Date: Jul. 8, 2004

(54) Method of setting parameters, web-server and telephone associated device

(76) Inventor: Hironori Nabeshima, Fukuoka (JP)

Correspondence Address: RATNERPRESTIA, P O BOX 980, VALLEY FORGE, PA, 19482-0980, US

(21) Appl. No.: 10/672,157

(22) Filed: Sep. 26, 2003

(30) Foreign Application Priority Data
Sep. 27, 2002 (JP) 2002-283154

(51) Int. Cl. H04L 12/28

(52) U.S. Cl. 370/351

(57) ABSTRACT

A method of parameters to a telephone associated device includes the steps of: (a) receiving a web-page to be used for setting the parameters by accessing from a client terminal (e.g., a personal computer registered by a user) to a web-server via a wide area network, (b) inputting parameter information onto the web-page by operating the client terminal, (c) transmitting the parameter information to the web-server, (d) then transmitting the parameter information to a CTI server via the wide area network, (e) transmitting the information with a DTMF signal or a modem signal from the CTI server to a modem mounted to the telephone associated device and hooked up to a public switched telephone network. This structure allows a user to set various conditions to the telephone associated device based on the parameter information.

### FIELD OF THE INVENTION

The present invention relates to a method of setting parameters for user-programming of telephone associated devices through the network, and relates to web-servers to achieve this method. It also relates to telephone associated devices, such as facsimile machines, to which parameters for user-programming can be set through the network.

### BACKGROUND OF THE INVENTION

Communication techniques have drastically changed the world in these 20-30 years. Two decades ago, analog telephones still dominated the market. Digital technique, mobile communication technique, and network technique have gained popularity, so that not only voices but also videos, music and other data can be transmitted fast, in bulk and with ease. As a result, a variety of servers on networks such as the Internet can offer services, which clients use at their own choice in their terminals, e.g., a personal computer or a cellular phone.

The personal computer or the cellular phone, which uses a keyboard for inputting information; however, leads a family or an individual to be e-mail oriented as an information provider, who now falls into a status of less submission but more reception of information. Further, there are still many people who are not accustomed to those devices. Amid these circumstances, a facsimile machine becomes a household item as a data-communication device, and it can transmit a hand-written message with ease as a data. Recently, many facsimile machines can be hooked up to the Internet, so that expectations are widely spread that those machines can be handled by anybody as information providing/collecting devices.

The facsimile machine is basically dialed to talk before reading a subject copy, and then the machine transmits the content of the copy. This is very simple operation; however, it is difficult to work the machine exerting various functions, and it is also difficult to set the program of those operations into the machine. A program cannot be prepared in the facsimile machine from a remote place. Japanese Patent Application Non-examined Publication H01-129642 (patent document 1: refer to page 2-3, FIG. 1 and FIG. 2) discloses a facsimile machine to which a user can store, change or additionally store subject information from a remote place.

This facsimile machine receives a digital tone multi-frequency (DTMF) signal transmitted through a telephone line, converts this signal into a digital code of 4-bit, then analyzes the digital code with a predetermined command code to know that subject information should be stored. The machine further obtains numerical information, which indicates the subject information, from DTME signals successively received, then stores the subject information in a memory.

The patent document 1; however, discloses facsimile machine how to deal with the DTMF signal of storing the subject information, and it does not teach how to transmit the DTMF signal. If an operation of transmitting the DTMF signal is complicated and difficult to understand, the facsimile machine according to the patent document 1 still has difficulty in storing and setting a program into the machine.

As discussed above, an operation of storing and setting programs in a facsimile machine for exerting a variety of functions is very difficult for users who are not accustomed to such an operation. On top of that, it was known that a program could not be stored or set in the machine from a remote place. The facsimile machine disclosed in the patent document 1 is supposed to solve this problem, and the machine allows users to store subject information in the machine from a remote place; however, the machine is only operated by using a DTMF signal, and nothing more. The patent document 1 does not teach how a user transmits the DTMF signal. If those users, who are not accustomed to the facsimile machine, struggle to transmit the DTMF signal at a remote place, the facsimile machine does not yet overcome the difficulty in storing or setting a program.

If a user of this facsimile machine does not store or set a program for himself or herself, and instead, the user asks an expert to do it, the expert must do the job at the user's place. It is a time-consuming work for the expert.

### SUMMARY OF THE INVENTION

The present invention provides a method of setting parameters for user programming of telephone associated devices. The method includes the steps of: (a) client terminal's accessing to a web-server via a wide-area network;

(b) client terminal's receiving a web-page for setting parameters from the web-server;

(c) inputting parameter-information on the web-page displayed on the client terminal;

(d) web-server's transmitting the parameter information to CTI server via the wide area network when the web-server receives the parameter information;

(e) CTI server's transmitting the parameter information to a modem of a telephone associated device hooked up to a public switched telephone network by using a DTMF signal or a modem signal; and

(f) telephone associated device's setting the parameter based on the parameter information.

### BRIEF DESCRIPTION OF THE DRAWINGS

FIG. 1 shows an overall picture illustrating a parameter setting to a facsimile machine in accordance with a first exemplary embodiment of the present invention.

FIG. 2 shows a structure of the facsimile machine in accordance with the first exemplary embodiment of the present invention.

FIG. 3 shows a structure of a web-server in accordance with the first exemplary embodiment of the present invention.

FIG. 4 shows a structure of a CTI-server in accordance with the first exemplary embodiment of the present invention.

FIG. 5 shows a structure of a command transmitted between the CTI server and the facsimile machine.

FIG. 6 shows a first sequence of setting parameters carried out by a facsimile setting system in accordance with the first exemplary embodiment of the present invention.

FIG. 7 shows a second sequence of setting parameters carried out by a facsimile setting system in accordance with the first exemplary embodiment of the present invention.

FIG. 8 shows a third sequence of setting parameters carried out by a facsimile setting system in accordance with the first exemplary embodiment of the present invention.

FIG. 9 shows a list of parameters set by a user in the first exemplary embodiment of the present invention.

FIG. 10 shows a screen set by a user in the first exemplary embodiment of the present invention.

### DESCRIPTION OF THE PREFERRED EMBODIMENTS

Exemplary embodiments of the present invention are demonstrated hereinafter with reference to the accompanying drawings.

Exemplary Embodiment 1

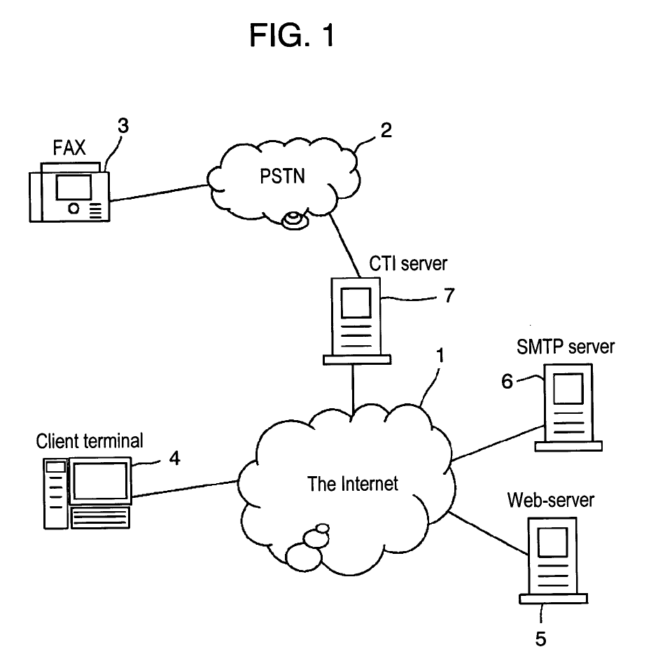

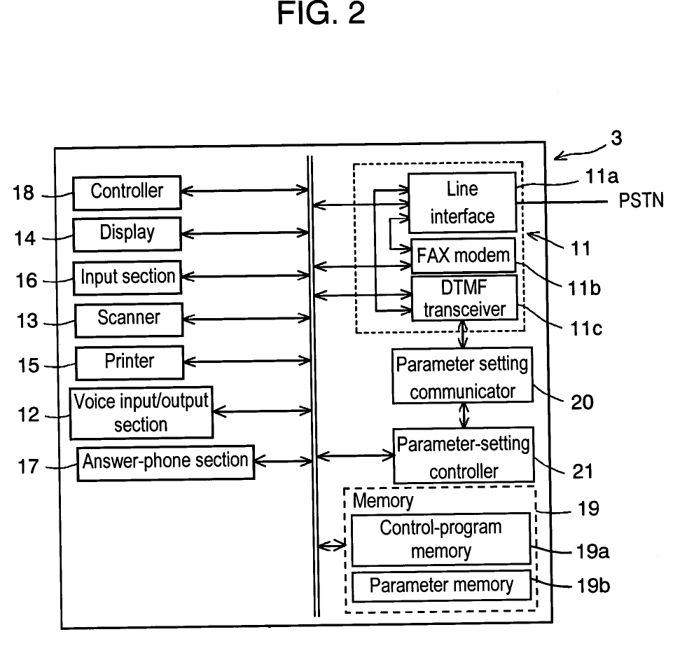

FIG. 1 shows an overall picture illustrating a parameter setting to a facsimile machine in accordance with the first exemplary embodiment. FIG. 2 shows a structure of the facsimile machine in accordance with the first exemplary embodiment. In FIG. 1, the Internet 1 (wide area network) transmits/receives data with protocol TCP/IP, public switched telephone network (PSTN) 2 allows providing a service of notifying a caller's TEL No. Facsimile machine (FAX) 3 is one of telephone associated devices, and client's terminal 4 such as a personal computer can receive a service of setting parameters from a server on the Internet 1. The first embodiment refers to a system of setting parameters to a FAX 3, so that the subject here is to set parameters in FAX 3; however, the present invention is not limited to the FAX as it will be discussed later. The present invention allows setting parameters to the telephone associated devices hooked up to PSTN 2 and equipped with a modem or a DTMF transceiver. Client terminal 4 may be a cellular phone instead of a personal computer.

Web-server 5 transmits a web-page upon request from client terminal 4 hooked up to the Internet 1. Simple mail transfer protocol (SMTP) server 6 transmits or receives an e-mail with protocol SMTP, and computer telephony integration (CTI) server 7 is hooked up to the Internet 1 and PSTN 2 for integrating the facsimile communication and e-mail.

SMTP server 6 is prepared for achieving the following functions: (1) the system of setting parameters to a FAX transmits or receives an e-mail between web-server 5 and CTI server 7 by using SMTP, and (2) the system shares SMTP server 6 with client terminal 4. Thus if a communication between web-server 5 and CTI server 7 is carried out by another method, and the client terminal 4 does not use an e-mail, this SMTP server 6 is not needed.

When the service of setting parameters is requested by a cellular phone hooked up to web-server 5, a web-page is written by Hypertext Markup Language (HTML), and this web-page must be managed under a different directory from that of a web-page written by HTML of a personal computer.

In the system of setting parameters to a FAX of the first embodiment, client terminal 4 is prepared to set parameters to FAX 3, and the setting is carried out on a web-page of web-server 5, and transmits this setting by using SMTP server 6 and CTI server 7 to FAX 3 and set the parameter there.

Next, a structure of FAX 3 in this parameter-setting system is described hereinafter. In FIG. 2, interface 11 is coupled to PSTN 2 and controls the communication. Line interface 11a controls a connection of PSTN, FAX modem 11b transmits or receives a facsimile, and DTMF transceiver 11c transmits or receives a DTMF signal.

Voice input/output section 12 includes a voice circuit and a voice is input through a microphone and output from a speaker, both are disposed in a handset (not shown). Scanner 13 reads a subject copy with CCDs and outputs data in MR/MH format transmittable by facsimile. Display 14 uses LCD for displaying, and printer 15 prints the data supplied from FAX modem 11b.

Input section 16 converts an input via a ten-key, function keys, a transmission button or other buttons into a code data, and answer-phone section 17 answers to a message arrived automatically and records it in a voice recorder (not shown). Answer-phone section 17 operates as discussed above.

Controller 18 controls FAX 3 overall, and memory 19 including control-program memory 19a and parameter memory 19b sets parameters (parameter information of the present invention) of various functions for FAX 3 to performs. Controller 18 works as a function achieving means such as reading out a control program from control-program memory 19a and prompting the CPU to execute the program. (Operate input section 16, thereby transmitting a request of transmitting parameters to the CTI server.)

Parameter setting communicator 20 inputs the data of the request of transmitting parameters into at least one of a communicating section of DTMF transceiver 11c or FAX modem 11b in order to transmit the request supplied from input section 16 to CTI server 7. When FAX 3 receives the parameters with a DTMF signal or a modem signal, parameter setting communicator 20 analyzes the parameters, and outputs parameter-information supplied from the input section to at least one of the communicating section of DTMF transceiver 11c or FAX modem 11b.

Parameter-setting controller 21 stores the parameters, which are to be set and transformed into coded data, into parameter memory 19b, or takes out those parameters from memory 19b and outputs them to parameter-setting communicator 20.

The elements discussed above, i.e., parameter-setting communicator 20, parameter-setting controller 21, and a practicing means of answer-phone 17 work as function-achieving means that reads out a program from control-program memory 19a and prompts the CPU to execute the program.

Fax 3 takes out the parameters by using parameter setting communicator 20, and stores them in parameter memory 19b by parameter setting controller 21 because the parameters are set in web-server 5 by client terminal 4, and transmitted to the phone No. of FAX 3 via CTI server 7 in a form of DTMF signal or other modem signal.

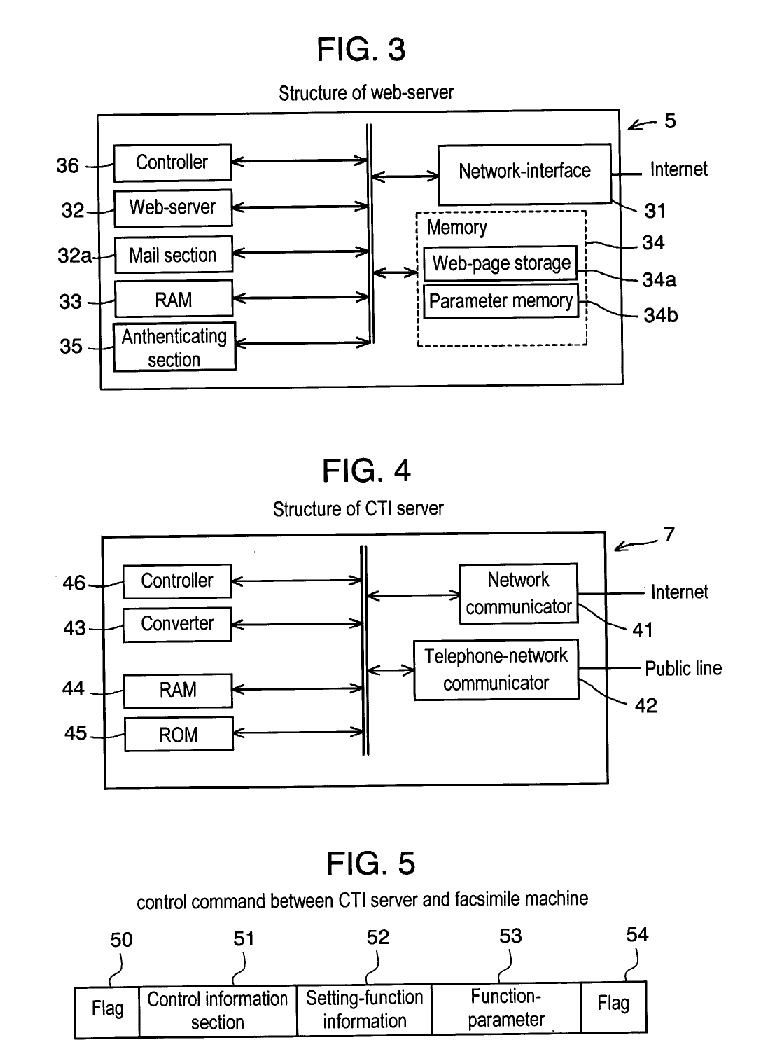

Next, a structure of web-server 5 in the system of setting parameters to the FAX is described hereinafter. FIG. 3 shows a structure of the web-server in accordance with the first exemplary embodiment. In FIG. 3, network-interface 31 controls the communication to/from the Internet 1, and web-server 32 transmits a web-page with protocol http. Mail section (notifying section) 32a deals with e-mails with SMTP. This web-server 5 includes RAM 33, memory 34, web-page storage 34a for storing web-pages of HTML transmitted from web-server 5, parameter memory 34b for storing the parameters to be set for operating FAX 3, and authenticating section 35 for setting the parameters.

Web-server 5 in the system of the first embodiment sets the parameters upon accessing from client terminal 4, and transmits the parameters to be set to SMTP server 6 via e-mail.

FIG. 4 shows a structure of CTI server 7 in accordance with the first embodiment. CTI server 7 includes the following elements:

network communicator 41 for controlling the communication to/from the Internet 1;

telephone-network communicator 42 for controlling the communication to/from PSTN 2;

converter 43 for integrating facsimile communication, SMTP communication, and http communication, thereby converting a format; and

controller 46 for controlling RAM 44, ROM 45 and CTI server 7.

When web-server 5 transmits the parameters to SMTP server 6 via an e-mail, server 6 transmits the e-mail to the telephone number of FAX 3. CTI server 7 converts this e-mail into DTMF signals or other modem signals before addressing it to the telephone number of FAX 3 via PSTN 2.

FIG. 5 shows a structure of a control command between CTI server 7 and FAX 3. In FIG. 5, flag 50 indicates a start of the control command, and control information section 51 describes contents of the command such as “request of transmitting the parameters”, “request of receiving the parameters”, “information transmission”, and “information receipt”. This control command includes setting-function information 52, function-parameter 53, and flag 54 indicating an end of the control command. For instance, information about setting a single-button dialing is programmed in setting-function information 52, and telephone numbers applicable to the single-button dialing are programmed in function-parameter 53.

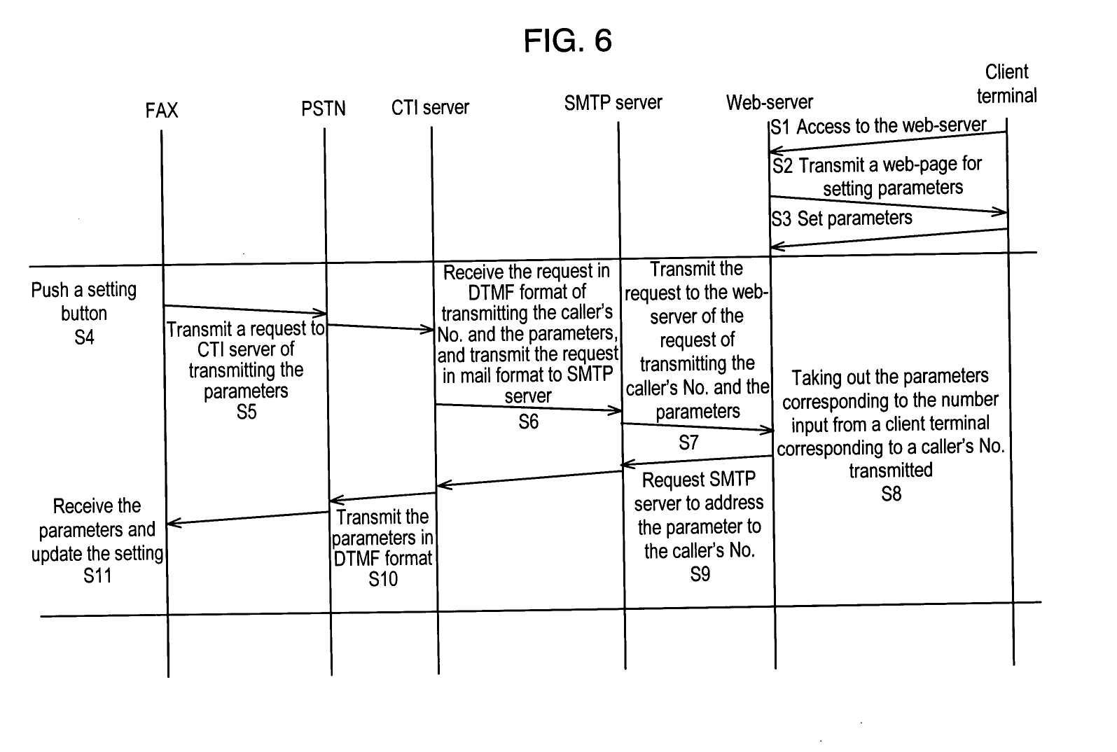

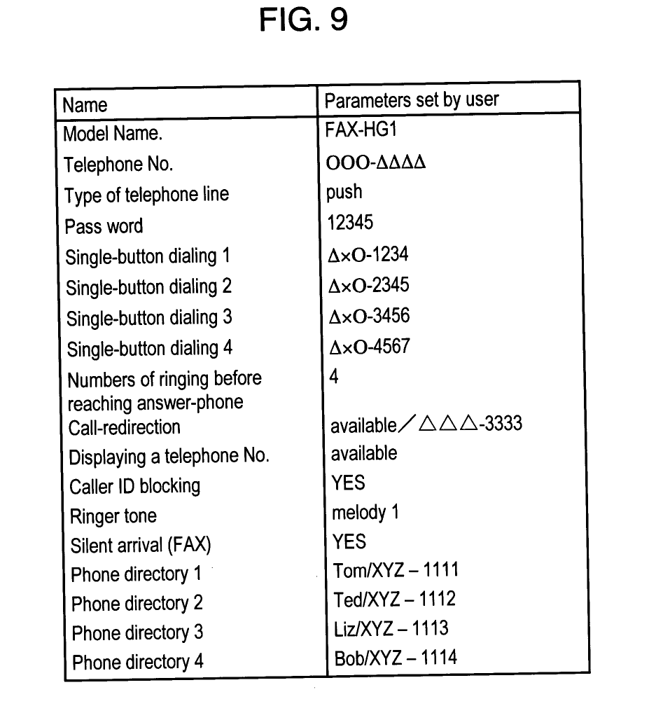

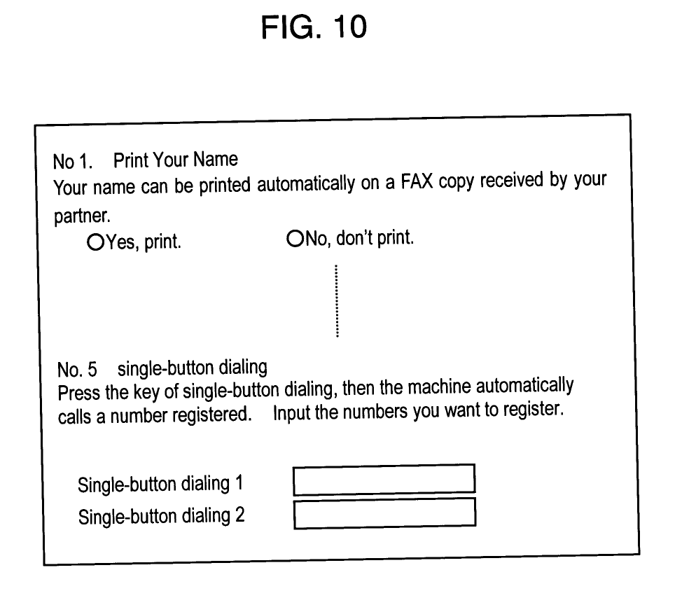

Sequences of an operation of setting the parameters in the system of setting the parameters to FAX is demonstrated hereinafter. A first sequence of setting the parameters is carried out when client terminal 4 accesses web-server 5 to set the parameters in the case of no formal registration available yet. FIG. 6 depicts the first sequence, and FIG. 9 lists the parameters for user programming, and FIG. 10 shows a screen where a user sets a program. As shown in FIG. 6, when client terminal 4 accesses web-server 5 to request a web-page for setting (S1), web-server 5 transmits the web-page as shown in FIG. 10 (S2). Client terminal 4 fills out the page and transmits it to web-server 5 (S3).

The screen of the web-page for setting prepares the blanks for a name, address, credit-card No. for identifying a subscriber, and further prepares blanks for model No., telephone No., a type of telephone line, single-button dialing, the number of ringing before reaching the answer-phone, call-redirection, displaying a telephone No., caller ID blocking, ringer tone, silent arrival, and phone directory. Web-server 5 stores those parameters in parameter memory 34b. Parameters for plural FAXes 3 can be input simultaneously to the screen of the web-page, so that those FAXes 3 are set in the same condition, namely, a group setting can be available. The web-page screen is preferably prepared to respective models of facsimile machines, because the single-button dialing and other functions are different from model by model. A preparation of a web-page for model-change would allows transmitting the data in accordance with a model replaced, and displaying a list of functions not supported by the model replaced.

Then a user depresses a button of FAX 3 at a certain time (S4), the control command in control information section 51 transmits the information of requesting the parameter transmission to CTI server 7 with DTMF signal via PSTN 2 (S5). This is done following a transmission procedure similar to High Level Data Link Control (HDCL). The information can be transmitted with other modem signals instead of DTMF signals.

CTI server 7 receives the request of parameter transmission in DTMF format, and at the same time, receives also a caller's number (number display) because the caller 's number (the telephone number of FAX 3) is added when the information passes through PSTN 2. CTI server 7 converts the request and the caller's phone No. into e-mail format from DTMF format, then transmits the e-mail to SMTP server 6 (S6), which transmits this e-mail to web-server 5 (S7).

Web-server 5 receives the request of setting parameters and the caller's phone No., then controller 36 searches parameter memory 34 for the phone No. set in S3 and identical to the caller's phone No. (S8). If the identical phone No. is found, controller 36 transmits the request to SMTP server 6 in order to require CTI server 7 to transmit the parameters to the caller's phone No., then server 6 transmits the request to CTI server 7.

CTI server 7 converts the request into a request of receiving the parameter in DTMF format based on the request of transmitting the parameters in e-mail format. In other words, CTI server 7 requires control-information section 51 to receive the parameter, stores the functions of the parameters into setting-function information 52, also stores the parameters into function-parameter 53, generates and transmits a control command for requesting of receiving the parameters in DTMF format to caller's phone No. (S10). This transmission is carried out following the transmission procedure similar to HDLC.

Receiving the request of receiving the parameters, FAX 3 converts the parameters into code data at parameter-setting communicator 20, and the coded data is stored in parameter memory 19b by parameter setting controller 21, so that the parameters are updated (S11).

The first sequence discussed above is used by a non-registered user in a trial period. In this trial period, such an input setting can be done in plural times, e.g., three times, because a user is not yet accustomed to the machine or the setting. The setting after the first time can omit S4-S7, and preferably starts with the input of a web-page and transmits parameters immediately. Because the first time setting already proves the correspondence between the phone No. of the facsimile machine and the phone No. input from the screen, and the correspondence between the facsimile machine and the user through a name, address, and credit card No. input.

The following options can be possible: If no credit card No. is available, S4-S7 should be carried out, and a maximum of three times setting per phone No. are allowed.

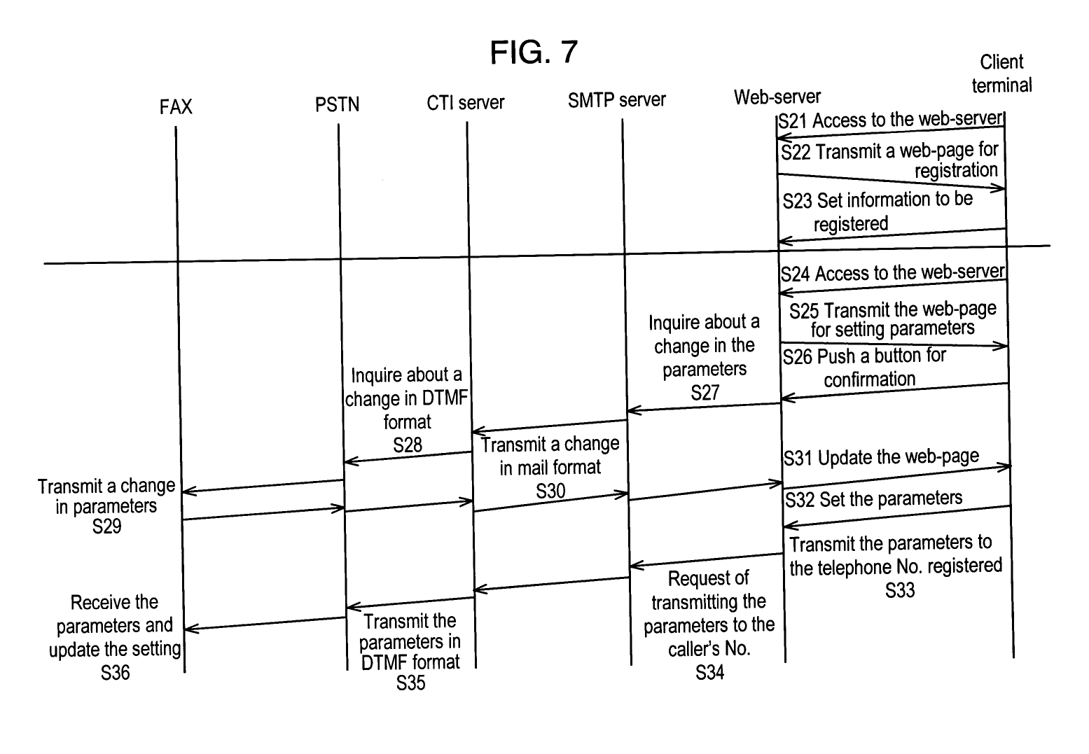

Next, a second sequence of setting parameters is described hereinafter. This second sequence is applicable to the case, where a client terminal formally registered accesses to web-server 5 for setting the parameters. FIG. 7 shows the second sequence carried out in the system of setting the parameters in accordance with the first embodiment. In FIG. 7, client terminal 4 accesses to web-server 5 to request a web-page for registration (S21), then web-server 5 transmits the web-page (S22). Client terminal 4 fills out the blanks and returns it to web-server 5 (S23). The blanks, filled with a name, address, credit No., and pass-word for identifying a subscriber, are stored in parameter memory 34b by web-server 5 together with the parameters listed in FIG. 9 for initial user programming.

Then web-server 5 uses an internal random-number generator (not shown) and user's information for generating its own authentic information to/from FAX 3. This authentic information is stored in parameter memory 34b, and transmitted from web-server 5 to CTI server 7, then to FAX 3 and stored in parameter memory 19b. After this, web-server 5 authenticates an access from FAX 3 at authenticating section 35 with this authentic information. After S23, it is preferable to carry out S1-S11 of the first sequence for identifying the caller's phone No.

Client terminal 4 then accesses to web-server 5 to request the web-page (S24), and web-server 5 transmits the web-page (S25), client terminal 4 displays a button for confirming the screen to be used for setting on the web-page, and a push of this button (S26) prompts transmitting an inquiry to SMTP server 6 whether or not another setting has been prepared in FAX 3 (S27), then CTI server 7 makes inquiry in DTMF format (S28).

FAX 3 transmits a change if the parameters have been changed (S29). Meanwhile, FAX 3 stores a history of changes in memory 19, and the history distinguishes the changes done by web-server 5 from the changes supplied by input section 16, so that if a second setting from input section 16 is done after a first setting by web-server 5, only the difference between the first and second ones can be transmitted, or all the parameters after the change can be transmitted.

CTI server 7 transmits the changes in e-mail format to web-server 5 (S30), and web-server 5 reflects the changes on the web-page before transmitting them to client terminal 4 (S31), which fills in the web-page with the parameters and returns it to web-server 5 (S32). Web-server 5 stores the parameters in parameter memory 34b. If the confirmation button is not pushed in S26, the sequence proceeds to S32 directly and transmits the changes to web-server 5.

Web-server 5 takes out the parameters including the changes from memory 34b, and transmits a web-page including the parameters for updating to client terminal 4. The web-page for updating includes the present setting as shown in FIG. 9, where the present setting is ready for being changed by client terminal 4. Change a parameter in the web-page and push an update-button, then web-server 5 requires CTI server 7 to transmit the changed parameter to the phone No. of FAX 3 (S33). This request is transmitted to SMTP server 6 (S34), which then transmits the request to CTI server 7, then server 7 converts it to a request of receiving the parameters in DTMF format and transmits the request to FAX 3 (S35).

FAX 3 receives the request of receiving the parameters, and converts the request into code data at parameter setting communicator 20, and the coded data is stored in parameter memory 19b by parameter setting controller 21 for updating the parameters (S36).

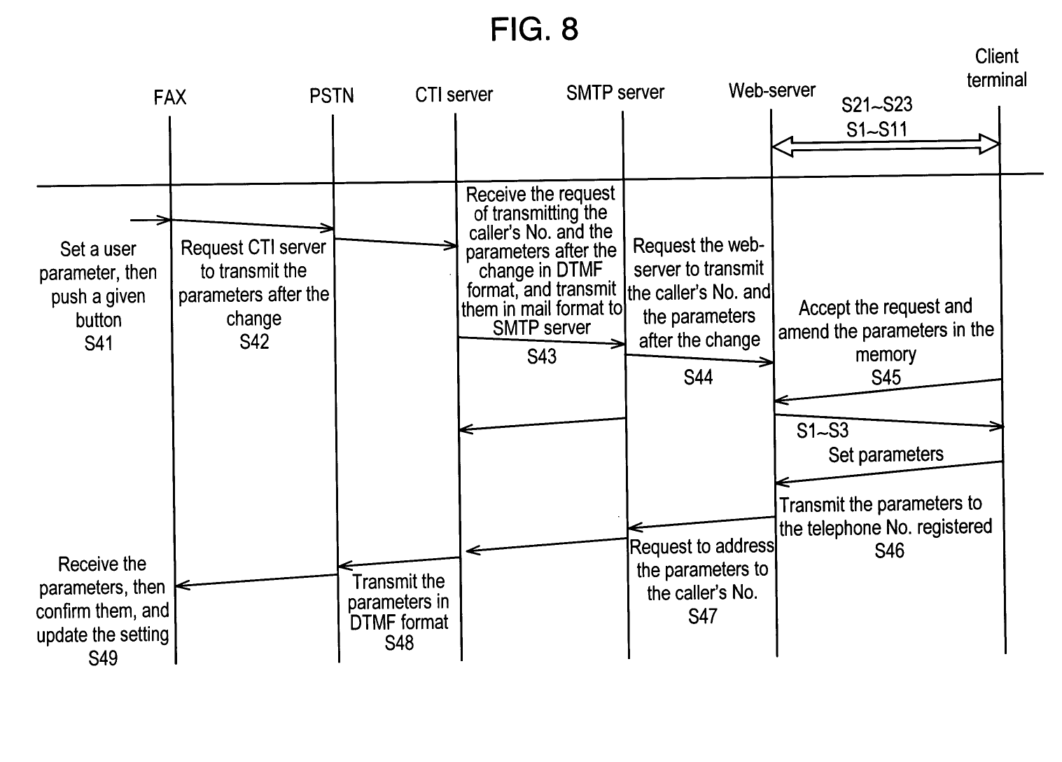

A third sequence of setting parameters is described hereinafter. The third sequence is applied to the case, where FAX 3 undergone the formal registration updates the parameters and informs web-server 5 of the update. FIG. 8 shows the third sequence carried out in the system of setting parameters in accordance with the first embodiment. In this third sequence, a user is allowed to select whether or not transmitting the update done in FAX 3 to web-server 5.

After S21-S23 of the second sequence followed by S1-S11 of the first sequence, a user wants to transmit a change of the parameters to web-server 5 at a certain time, and the user depresses a setting button of FAX 3 as depicted in FIG. 8 (S41). Then a request of transmitting the change of the parameters is transmitted together with authentic data with DTMF signals to CTI server 7 via PSTN 2 (S42). At this time, the transmission is carried out following the procedure similar to HDLC.

CTI server 7 receives the request of parameter transmission in DTMF format, and at the same time, receives also a caller's number (number display) because the caller's number (the telephone number of FAX 3) is added when the information passes through PSTN 2. CTI server 7 converts the request, authentic information and the caller's phone No. into e-mail format from DTMF format, then transmits the e-mail to SMTP server 6 (S43), which transmits this e-mail to web-server 5 (S44).

Web-server 5 receives the request of transmitting the parameters and the caller's phone No., then authenticates those data with the authentication information at authenticating section 35. Controller 36 reads out registered information managed by the authentication information from parameter memory 34b, and updates the registered information to the changes received (S45). After that the same procedure as S1-S3 of the first sequence is carried out for setting the parameters, then web-server 5 addresses the parameters to the registered phone No. and transmits them to CTI server 7 (S46). STMF server 6 receives it and transmits it to CTI server 7 (S47), which converts the request into a request of receiving the parameters in DTMF format and addresses the request to the caller's phone No. (S48).

Receiving the request of receiving the parameters, FAX 3 converts the parameters into code data at parameter-setting communicator 20, and controller 18 displays the coded data on display 14. If some discrepancy is found between the parameters transmitted from FAX 3 and the parameters received, whether or not the updating is carried out must be determined before finalization. This finalization prompts parameter setting controller 21 to store the parameters of the coded data in parameter memory 19b (S49). Therefore, the user is allowed to acknowledge what kind of parameters are set before the parameters are stored in memory 19b, thereby making the user feel easy. Further, if an error exists in setting on the web-page, the setting can be prevented from being set to FAX 3. The parameters transmitted can skip the display and be stored directly in memory 19b, such a mode can be prepared at user's option.

As discussed above, the system of setting parameters to a facsimile machine in accordance with the first embodiment can set parameters from any client terminal 4 hooked up to the Internet 1.

According to the method of setting parameters of telephone associated devices of the present invention, the associated device receives a web-page to be used for setting parameters from the client's terminal and the parameter information is supplied therefrom. Thus the information can be obtained from anywhere and in a simpler manner than the case where the information is directly input to the device. The parameter information in HTML format is converted into DTMF signals or modem signals, so that the telephone associated device can set the parameters automatically. For instance, a user, who is not accustomed to setting of a variety of functions, feels difficulty in setting parameters; however, according to the present invention, the user can set the parameters on the network with ease. In the case of the information being registered in the web-server, authentication information is associated to the registered information, so that when the telephone associated device accesses to the web-server, the registered information can be positively controlled.

Since the web-page is received via the client terminal for obtaining the parameter information, the information can be obtained from anywhere with ease. The telephone associated device requests the transmission of the parameters, thereby downloading the parameter information, so that even if the authentication information is not stored, the user can be authenticated with ease. Further, a caller's phone No. is taken out from the notice of caller's phone No., so that the load of the facsimile machine can be reduced. The parameter information can be picked out with the caller's phone No, so that the authentication can be carried out with the phone No. in a simple manner and with ease even if the authentication information is not stored.

Use of the web-page allows registering a user to the web-server with ease, and the user registered can confirm the parameter information in the web-page through inputting some data, so that the user can know with ease a change due to another setting of parameters to the facsimile machine. The parameter information can be transmitted from a web-server to a CTI server via e-mail.

According to the telephone-associated device of the present invention, the device can transmit parameter-information using a modem signal or a DTMF signal, and a controller can easily program functions of the device following the parameter information. Since the authentication information accompanies the communication to the web-server, the registered information is managed without fail when the device accesses the web-server.

The web-server of the present invention receives the web-page to be used for setting parameters from a client terminal for inputting the parameter information, the information can be input from anywhere with ease. The parameter information in HTML format is transmitted to the CTI server, so that the telephone associated device can set the parameters automatically. Use of the web-page allows registering a user to the web-server with ease, and the registered information is managed without fail when the telephone-associated device accesses the web-server.

According to the CTI server of the present invention, the parameter information received from the wide area network is in e-mail format, and the parameter information in e-mail format is converted to a format receivable by the telephone-associated device.

What is claimed is:

1. A method of setting a parameter to a telephone associated device, the method comprising the steps of:
(a) accessing from a client terminal to a web-server via a wide area network;
(b) receiving at the client terminal a web-page to be used for setting the parameters from the web-server;
(c) inputting parameter information on the web-page displayed on the client terminal;
(d) transmitting the parameter information from the web-server to a CTI server via the wide area network after the parameter information is received by the web-server;
(e) transmitting the parameter information with one of a DTMF signal and a modem signal from the CTI server to a modem of the telephone associated device hooked up to a public switched telephone network; and
(f) setting the parameters to the telephone associated device based on the parameter information.

2. A method of setting a parameter to a telephone associated device, the method comprising the steps of:
(a) accessing from a client terminal to a web-server via a wide area network;
(b) receiving at the client terminal a web-page to be used for setting the parameters from the web-server;
(c) inputting parameter information on the web-page displayed on the client terminal;
(d) transmitting a request of transmitting the parameter to be set to the web-server upon transmission of the request of transmitting the parameter from the telephone associated device to a CTI server after the parameter information is received by the web-server;
(e) upon a transmission of the parameter information from the web-server to the CTI server via the wide area network, transmitting the parameter information with one of a DTMF signal and a modem signal from the CTI server to a modem of the telephone associated device hooked up to a public switched telephone network; and
(f) setting the parameter to the telephone associated device based on the parameter information.

3. The method of setting a parameter to a telephone associated device of claim 2, the method further comprising the step of: when the request of transmitting the parameter to be set to the CTI server, transmitting a caller's No., obtained by the CTI server from a notice of a caller's No. through the public switched telephone network, to the web-server together with the request.

4. The method of setting a parameter to a telephone associated device of claim 1, the method further comprising the step of: accessing to the web-server via the wide area network, then receiving the web-page from the web-server before inputting registered information, and transmitting the registered information to the web-server.

5. The method of setting a parameter to a telephone associated device of claim 4, the method further comprising the step of: inquiring from the web-server about a change in the parameter information of the telephone associated device via the CTI server, and transmitting the change to the client terminal via the web-page when the client terminal accesses the web-server via the wide area network, then receives the web-page from the web-server, and inputs some data for acknowledging the parameter information.

6. The method of setting a parameter to a telephone associated device of claim 1, the method further comprising the step of: transmitting the parameter information from the web-server to an SMTP server via e-mail, then transmitting the e-mail from the SMTP server to the CTI server.

7. The method of setting a parameter to a telephone associated device of claim 1, wherein the telephone associated device is a facsimile machine.

8. The method of setting a parameter to a telephone associated device of claim 6, wherein the telephone associated device is a facsimile machine.

9. The method of setting a parameter to a telephone associated device of claim 4, wherein when the registered information is stored, authentication information is stored in both the web-server and the telephone associated device for controlling the registered information responsive to each one piece of the authentication information.

10. The method of setting a parameter to a telephone associated device of claim 6, wherein when the registered information is stored, authentication information is stored in both the web-server and the telephone associated device for controlling the registered information responsive to each one piece of the authentication information.

11. The method of setting a parameter to a telephone associated device of claim 7, wherein when the registered information is stored, authentication information is stored in both the web-server and the telephone associated device for controlling the registered information responsive to each one piece of the authentication information.

12. The method of setting a parameter to a telephone associated device of claim 8, wherein when the registered information is stored, authentication information is stored in both the web-server and the telephone associated device for controlling the registered information responsive to each one piece of the authentication information.

13. A telephone associated device comprising:
(a) a line interface to be hooked up to a public switched telephone network for communication;
(b) a communicating section included in at least one of a modem for converting data into a modem signal and a DTMF transceiver for converting data into a DTMF signal;
(c) a parameter setting communicator for inputting data of a request of transmitting a parameter to the communicating section in order to transmit the request supplied from an input section to a CTI server, and analyzing the parameter information supplied from the communicating section when the parameter information is transmitted via the public switched telephone network; and
(d) a controller for storing the parameter information supplied from the parameter setting communicator into a memory, and setting functions according to the parameter information.

14. The telephone associated device of claim 13, wherein the parameter setting communicator further outputs parameter information supplied through the input section to the communicating section.

15. The telephone associated device of claim 13, wherein the memory stores authentication information, which is transmitted during a communication with a web-server.

16. The telephone associated device of claim 13, wherein the modem is a facsimile modem, and the device is a facsimile machine including the facsimile modem.

17. The telephone associated device of claim 14, wherein the modem is a facsimile modem, and the device is a facsimile machine including the facsimile modem.

18. The telephone associated device of claim 13 further comprising: a history memory for storing a history of changes in the parameters, wherein the history memory distinguishes a change in the parameters set by the web-server from a change through an input section of the device.

19. A web-server comprising:
(a) a web-page storage for storing a web-page to be used for setting a parameter to a telephone associated device;
(b) a parameter memory for storing parameter information of the respective telephone associated devices;
(c) a web-server section for transmitting the web-page upon request from a client terminal, and when the parameter information is input to the web-page, reflecting the parameter information to the web-page and storing the parameter information in the parameter memory; and
(d) a notifying section for transmitting the parameter information to a CTI server when the parameter information is supplied.

20. The web-server of claim 19, wherein the server stores the web-page, which is to receive registered information, in the web-page storage, transmitting the web-page upon request from the client terminal, and receiving the registered information before storing it to the parameter memory.

21. The web-server of claim 20, wherein authentication information is stored in both of the web-server and the telephone associated device, and the web-server further comprising an authenticating section for carrying out authentication with the authentication information.

22. The web-server of any one of claim 19, wherein the notifying section is a mailing section that transmits an e-mail with SMTP protocol.

23. A CTI server comprising:
a network communicating section for communicating with a web-server via a wide area network;
a telephone network communicating section for controlling a communication with a public switched telephone network; and
a converter for converting parameter information in a mail-format received from the web-server into one of a DTMF signal and a modem signal receivable to a telephone associated device.

24. The method of setting a parameter to a telephone associated device of claim 2, the method further comprising the step of: transmitting the parameter information from the web-server to an SMTP server via e-mail, then transmitting the e-mail from the SMTP server to the CTI server.

25. The method of setting a parameter to a telephone associated device of claim 2, wherein the telephone associated device is a facsimile machine.

26. The method of setting a parameter to a telephone associated device of claim 24, wherein the telephone associated device is a facsimile machine.

27. The method of setting a parameter to a telephone associated device of claim 5, wherein when the registered information is stored, authentication information is stored in both the web-server and the telephone associated device for controlling the registered information responsive to each one piece of the authentication information.

28. The method of setting a parameter to a telephone associated device of claim 24, wherein when the registered information is stored, authentication information is stored in both the web-server and the telephone associated device for controlling the registered information responsive to each one piece of the authentication information.

29. The method of setting a parameter to a telephone associated device of claim 25, wherein when the registered information is stored, authentication information is stored in both the web-server and the telephone associated device for controlling the registered information responsive to each one piece of the authentication information.

30. The method of setting a parameter to a telephone associated device of claim 26, wherein when the registered information is stored, authentication information is stored in both the web-server and the telephone associated device for controlling the registered information responsive to each one piece of the authentication information.

31. The telephone associated device of claim 14, wherein the memory stores authentication information, which is transmitted during a communication with a web-server.

32. The telephone associated device of claim 14 further comprising: a history memory for storing a history of changes in the parameters, wherein the history memory distinguishes a change in the parameters set by the web-server from a change through an input section of the device.

33. The web-server of any one of claim 20, wherein the notifying section is a mailing section that transmits an e-mail with SMTP protocol.

34. The web-server of any one of claim 21, wherein the notifying section is a mailing section that transmits an e-mail with SMTP protocol.
